(19) United States
(12) Patent Application Publication
(10) Pub. No.: US 2010/0038292 A1
(43) Pub. Date: Feb. 18, 2010

(54) Apparatus for Desalination and Pressure Washing

(75) Inventor: Jess Edward Fike, Lafayette, LA (US)

Correspondence Address: Jones, Walker, Waechter, Poitevent, Carrere,;Denegre, L.L.P., 5th Floor, Four United Plaza, 8555 United Plaza Boulevard, Baton Rouge, LA, 70809, US

(73) Assignee: H2O, Inc.

(21) Appl. No.: 12/192,498

(22) Filed: Aug. 15, 2008

(51) Int. Cl. C02F 1/58; C02F 1/44; B01D 21/30; C02F 103/08; B01D 35/157

(52) U.S. Cl. 210/87; 210/258; 210/143; 210/123; 210/137; 210/132

(57) ABSTRACT

An apparatus that combines desalination and pressure washing. The apparatus includes separate inlets for seawater and for freshwater. The apparatus includes a first diverter valve to selectively permit the flow of seawater or freshwater into the apparatus. The apparatus also contains a second diverter valve for directing the flow of seawater or freshwater to a pressure-washer outlet for pressure washing or directing the flow of seawater to a desalination assembly such as a reverse-osmosis (RO) membrane for desalination. The apparatus contains one or more pumps sufficient to generate fluid pressure for pressure washing and generating a driving pressure across the desalination assembly. A variable frequency drive system may be included in the apparatus to regulate the RO pump flow rate across a fixed orifice thereby regulating driving pressure and in turn the freshwater production rate from the RO system.

### FIELD OF THE INVENTION

The present invention relates to an apparatus for desalination and pressure washing and more particularly to a device that combines reverse-osmosis desalination and pressure washing.

### BACKGROUND OF THE INVENTION

Desalination devices are used to produce potable water from saltwater such as seawater. Desalination equipment may contain a reserve osmosis filtration membrane that removes salts and other impurities from seawater to make drinkable water. A desalination system using a reverse osmosis membrane is described in U.S. Pat. No. 5,503,735, which is incorporated herein by reference. Desalination systems are used in a variety of settings but are commonly found on offshore drilling or production platforms where the need for potable water is necessary as a drinking source for rig personnel but also for use in industrial applications such as cleaning equipment.

Pressure washers are used to provide pressurized water in certain spray patterns to clean objects such as equipment, houses, cars and the like. Pressure washers include as components a water inlet, an electric or motor operated pump, outlet, hose and nozzle. Water is supplied to the pressure washer from a water source such as a water line. In offshore rigs, pressure washers are routinely used to clean offshore equipment, the rig floor, and other surfaces.

Space is at a premium on offshore rigs. Additionally, the cost associated with transporting equipment to the rig (by supply boat or helicopter) is expensive. Operators of drilling and production rigs are always searching for way to reduce equipment and costs.

### SUMMARY OF THE INVENTION

It is an object of the present invention to achieve greater economies by combining desalination and pressure washing into a single piece of equipment.

This object and others are achieved by a unique apparatus for desalination of saltwater (e.g., seawater) and for pressure washing with either saltwater or freshwater. The apparatus includes a saltwater inlet conduit for saltwater and a freshwater inlet conduit for freshwater. The apparatus has a first valve in fluid communication with the saltwater and freshwater inlet conduits. The apparatus also has a low-pressure pump in fluid communication with the first valve. A high-pressure pump is also provided. The high-pressure pump is in fluid communication with the low-pressure pump. The apparatus may also have a second valve in fluid communication with the high-pressure pump. A pressure-washer conduit is also included in the apparatus. The pressure-washer conduit is in fluid communication with the second valve.

The apparatus also includes a desalination assembly in fluid communication with the second valve. The desalination assembly desalinates the saltwater to make freshwater. A freshwater outlet conduit is also incorporated in the apparatus. The freshwater outlet conduit is in fluid communication with the desalination assembly. The apparatus further has a saltwater outlet conduit in fluid communication with the desalination assembly.

In the apparatus, the first valve selectively permits the flow of either saltwater from the saltwater inlet conduit or freshwater from the freshwater inlet conduit to the second valve. The second valve selectively permits the saltwater or the freshwater to flow either to the pressure-washer outlet conduit for use in pressure washing or to the desalination assembly. Saltwater driven across the desalination assembly is desalinated. Salt and other impurities are removed from the water to make it safe to drink. Freshwater may be driven across the desalination assembly to clean the assembly.

The first valve may be manually or automatically operated. The first valve may be a ball valve.

The low-pressure pump may generate a fluid pressure in the range of 10 PSI to 50 PSI. The low-pressure pump may generate a fluid pressure of at least 30 PSI. The low-pressure pump may be a centrifugal pump.

The high-pressure pump may generate fluid pressure in the range of 500 PSI to 4,000 PSI. The high-pressure pump may generate fluid pressure of at least 1,000 PSI. The high-pressure pump may be a positive displacement pump such as a plunger operated pump or a piston operated pump.

The desalination assembly may include a reverse-osmosis membrane. The reverse-osmosis membrane may be a spiral wound thin-film composite membrane.

The embodiment of the present invention described above may include an unloading valve operatively connected to the pressure-washer outlet conduit. The unloading valve may also be in fluid communication with the high-pressure pump. The unloading valve diverts excess saltwater or freshwater flowing through the pressure-washer outlet conduit back to the high-pressure pump via suction generated by the high-pressure pump.

An alternative embodiment of the apparatus of the present invention includes a saltwater inlet conduit for saltwater and a freshwater inlet conduit for freshwater. The apparatus has a first valve in fluid communication with the saltwater and freshwater inlet conduits. The apparatus also has a low-pressure pump in fluid communication with the first valve. A high-pressure pump is also provided. The high-pressure pump is in fluid communication with the low-pressure pump. The apparatus may also have a second valve in fluid communication with the high-pressure pump. A pressure-washer conduit is also included in the apparatus. The pressure-washer conduit is in fluid communication with the second valve.

The alternative apparatus also includes a desalination assembly in fluid communication with the second valve. The desalination assembly desalinates the saltwater to make freshwater. A freshwater outlet conduit is also incorporated in the apparatus. The freshwater outlet conduit is in fluid communication with the desalination assembly. The alternative apparatus further has a saltwater outlet conduit in fluid communication with the desalination assembly.

The alternative apparatus includes a variable frequency drive assembly operatively connected to the high-pressure pump. The alternative apparatus also has a flow-rate sensor operatively connected to the freshwater outlet conduit and to the variable frequency drive assembly. The flow-rate senor measures the flow rate of freshwater in the freshwater outlet conduit and transmits the measured flow-rate to the variable frequency drive assembly. The alternative apparatus further includes a flow-restriction means operatively associated with the saltwater outlet conduit.

In the alternative apparatus, the first valve selectively permits the flow of either saltwater from the saltwater inlet conduit or freshwater from the freshwater inlet conduit to the second valve. The second valve selectively permits the saltwater or the freshwater to flow either to the pressure-washer outlet conduit for use in pressure washing or to the desalination assembly. Saltwater driven across the desalination assembly is desalinated. Salt and other impurities are removed from the water to make it safe to drink. Freshwater may be driven across the desalination assembly to clean the assembly.

The variable frequency drive assembly selectively increases or decreases the speed of the motor of the high-pressure pump to control the driving pressure of saltwater across the desalination assembly. The flow-restriction means also regulates the driving pressure of the saltwater across the desalination assembly.

The desalination assembly in the alternative embodiment may include a reverse-osmosis membrane. The reverse-osmosis membrane may be a spiral wound thin-film composite membrane.

The variable frequency assembly may have a PID loop software that selectively increases or decreases the speed of the motor of the high-pressure pump to control the driving pressure of the saltwater across the desalination assembly.

The flow-restriction means may include a tube having a bore with an inner diameter that is smaller than the inner diameter of the saltwater outlet conduit. The flow-restriction means may also include a stem needle valve.

The alternative embodiment may also have an unloading valve operatively connected to the pressure-washer outlet conduit and in fluid communication with the high-pressure pump. The unloading valve diverts excess saltwater or freshwater flowing through the pressure-washer outlet conduit back to the high-pressure pump.

This and many other objects and advantages will be readily apparent to one skilled in the art to which the invention pertains from a perusal of the claims and the following detailed description of the preferred embodiments and read in conjunction with the appended drawings.

### BRIEF DESCRIPTION OF THE DRAWINGS

FIG. 1 is a schematic representation of an embodiment of the present invention.

FIG. 2 is a pictorial front view of the embodiment of the present invention.

FIG. 3 is a pictorial back view of the embodiment of the present invention shown in FIG. 2.

### DETAILED DESCRIPTION OF PREFERRED EMBODIMENTS

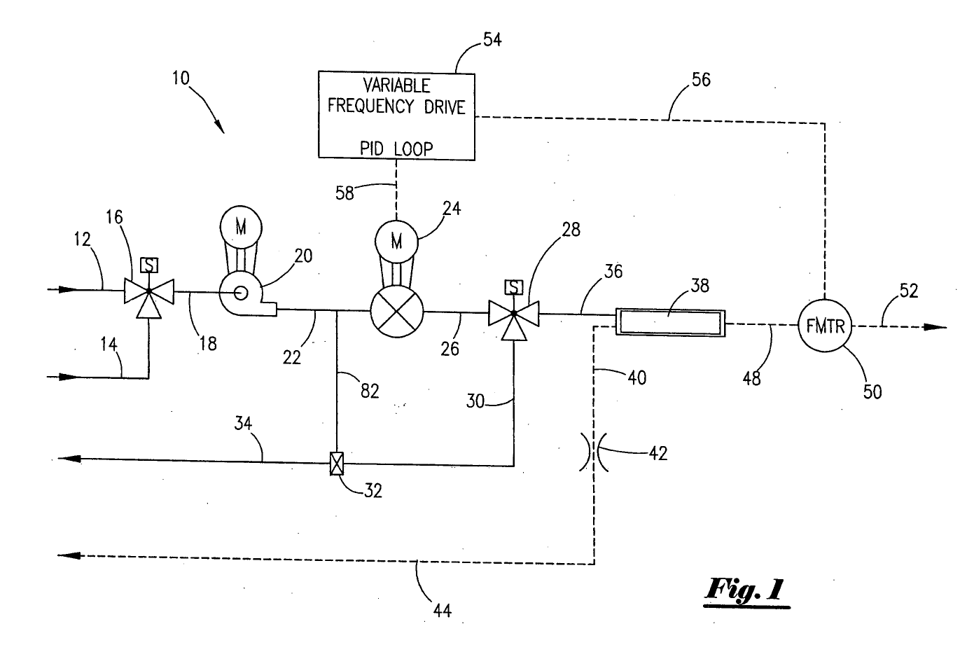

With reference to the figures where like elements have been given like numerical designation to facilitate an understanding of the present invention, and particularly with reference to the embodiment of the present invention illustrated in FIG. 1, the combination desalinator and pressure washing unit 10 includes seawater inlet conduit 12 and freshwater inlet conduit 14. Seawater inlet conduit 12 is fluidly connected to a source of seawater. For example, conduit 12 may include an end [not shown] that is placed into a seawater source such as an ocean, sea, or saltwater lake. Freshwater inlet conduit 14 is fluidly connected to a freshwater source. For example, conduit 14 may include an end [not shown] that is placed into a freshwater source such as a freshwater lake, pond, well, or tank. Conduit 14 may also be connected to a freshwater source such as a potable water line or system.

As shown in FIG. 1, conduits 12 and 14 are each fluidly connected to diverter valve 16. Diverter valve 16 may be any type of valve that acts to selectively block or permit the passage of seawater (in the case of conduit 12) or freshwater (in the case of conduit 14) through valve 16. Valve 16 may be manually or electronically actuated. Valve 16 may be a ball valve, as for example, a three-way diverter ball valve commercially available from Banjo Corporation of Crawfordsville, Ind. under model number V075SL. Valve 16 may also be an electronically actuated three-way diverter ball valve commercially available from Evsco Inc. of Libertyville, Ill. under model number 423PP1-RE1115VAC.

With reference to FIG. 1, conduit 18 fluidly connects valve 16 to boost pump 20. Conduit 22 fluidly connects boost pump 20 to positive displacement pump 24. Conduit 22 may contain a filtration device (not shown). Boost pump 20 acts to pump seawater from the seawater source to positive displacement pump 24 via conduit 12, valve 16, conduit 18, and conduit 22. Boost pump 20 also acts to pump freshwater from the freshwater source to positive displacement pump 24 via conduit 14, valve 16, conduit 18, and conduit 22. Boost pump 20 can be any type of pump capable of pumping fluid (e.g., seawater and/or freshwater) to positive displacement pump 24. For example, boost pump 20 may be a centrifugal pump. Boost pump 20 may be a centrifugal pump commercially available from March Mfg., Inc. of Glenview, Ill. under model number 335-CP-MD. Boost pump 20 may generate fluid pressure of at least 30 PSI.

Positive displacement pump 24 acts to increase the fluid pressure of both the seawater and the freshwater within unit 10. Positive displacement pump 24 is capable of increasing the fluid pressure of the seawater fluid and the freshwater to a pressure range of at least 1,000 PSI. Positive displacement pump 24 may be any type of pump capable of producing pressure in the range mentioned herein. Positive displacement pump 24 may be a triplex plunger pump or an axial piston style pump. Positive displacement pump 24 may be a triplex plunger pump commercially available from General Pump of Minnesota under model number WM3015C.

Again with reference to FIG. 1, conduit 26 fluidly connects positive displacement pump 24 to second diverter valve 28. Second diverter valve 28 acts to divert freshwater flowing through conduit 26 to conduit 30 and to pressure washer conduit outlet 34. Second diverter valve 28 may be any type of valve that acts to selectively permits the passage of seawater in conduit 26 to conduit 36 (while preventing passage to conduit 30) or to selectively permit the passage of freshwater in conduit 26 to conduit 30 (while preventing passage to conduit 36). Second diverter valve 28 may be a ball valve. Second diverter valve 28 may be a three-way diverter ball valve commercially available from Anderson Brass Company of Hartsville, S.C. under model number 53222BVLSS.

FIG. 1 shows that unloading valve 32 fluidly connects conduit 30 and pressure washer conduit outlet 34. Unloading valve 32 automatically diverts any unused freshwater back to conduit 22, through conduit 82, where it is pumped back to positive displacement pump 24 for re-circulation through conduit 26, second diverter valve 28, and conduit 30. Unloading valve 32 may be any type of valve that acts to selectively divert excess freshwater in conduits 30, 34. Unloading valve 32 may be a flap type valve or ball valve. Unloading valve 32 is commercially available from General Pump of Minnesota under model number YU815D.

To produce potable freshwater from seawater or saltwater, diverter valve 16 is actuated to a position that permits the flow of seawater through conduit 14 to boost pump 20 via conduit 18 as sown in FIG. 1. The seawater then flows from boost pump 20 to positive displacement pump 24 via conduit 22. From positive displacement pump 24, the seawater flows through conduit 26 to second diverter valve 28. Valve 28 is actuated to a position that permits the seawater to flow to desalination assembly or RO membrane 38 via conduit 36. RO membrane 38 may be a spiral wound thin-film composite type membrane such as the reverse osmosis membrane commercially available from FilmTec Corporation of Minneapolis, Minn. under model number SW30HRLE-4040. RO membrane 38 functions to remove dissolved salts in the seawater by reverse osmosis to produce potable water or freshwater. The produced freshwater flows from RO membrane 38 via conduit 48 to flow transmitter 50. Flow transmitter 50 measures the flow of the produced freshwater and provides a visible indicator of such flow rate.

FIG. 1 also illustrates that the driving or flow pressure of the seawater across RO membrane 38 is controlled by an automatic product water volume control mechanism that includes fixed orifice 42 and a varying flow rate. Orifice 42 is determinative of the amount of pressure in the line. Orifice 42 may be a bored flow control orifice tube such as a laser precision bored flow control orifice tube commercially available from Lenox Laser of Glen Arm, Md. under model number SSP-1/4-Tube, which has an orifice precision drilled by a laser to a micron size sufficient to regulate the driving pressure of the seawater across RO membrane 38. Orifice 42 may also be a valve such as a stem needle valve or a 316SS regulating stem needle valve. Stem needle valves would be used in smaller systems such as the model available from Omega under model number FVL-413-SS.

Positive displacement pump 24 delivers a fixed-volume of water per revolution. Variable frequency drive 54 contains PID loop software that increases or decreases the revolutions-per-minute (rpm) of positive displacement pump 24, which in turn varies the flow rate of pump 24. The flow rate of pump 24 and the size of orifice 42 constitute the automatic product water volume control mechanism and control the driving or flow pressure of seawater across RO membrane 38 to maintain a preset product water flow as registered by flow transmitter 50. Variable frequency drive 54 is operatively connected to positive displacement pump 24 via line 58. Variable frequency drive 54 is operatively connected to flow transmitter 50 via line 56. Variable frequency drive 54 is commercially available from Lenze AC Tech under model number ESV152N02SFC V/Hz Variable Frequency Drive. Flow transmitter 50 may be any type of device that measures fluid velocity such as the transmitter commercially available from Gems Sensors & Controls of Plainville, Conn. under model number 170280 Paddle Wheel Type with 0-10V Output.

Again as seen in FIG. 1, freshwater or potable water produced by RO membrane 38 flows through conduit 48, through flow transmitter 50 to freshwater outlet conduit 52. Freshwater exiting conduit 52 may be used for a variety of purposes including drinking water for humans and animals.

FIG. 1 also reveals that excess seawater entering RO membrane 38 that is not otherwise converted to potable water is redirected through conduit 40, pass fixed orifice 42, to seawater outlet conduit 44. Seawater exiting conduit 44 may be deposited back to the seawater source or collected for use in a variety of applications where seawater could be used. Approximately 70% of the seawater driven across RO membrane 38 is returned via conduit 40.

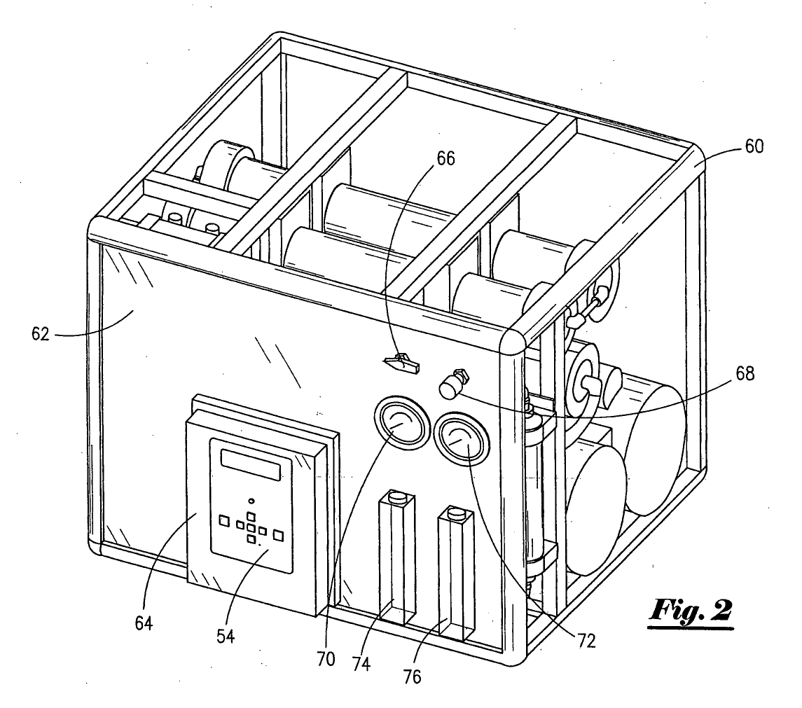

FIG. 2 depicts unit 10 encased within housing 60. Housing 60 may have front face 62. Front Face 62 may contain operational controls and parameter signals for unit 10. For example, front face 62 may have panel 64 constituting the operational mechanism for variable frequency drive 54. Front face 62 may also contain actuation switch 66 to actuate valve 28. Driving pressure of fluid across RO membrane 38 may be controlled by control knob 68 on front face 62. Front face 62 may also contain gauge 70 that shows the driving pressure of the fluid across RO membrane 38 and gauge 72 that shows pump inlet pressure created by boost pump 20. Front face 62 may also contain gauge 74 that displays the freshwater production rate measured by flow transmitter 50 and gauge 76 that displays the feed flow.

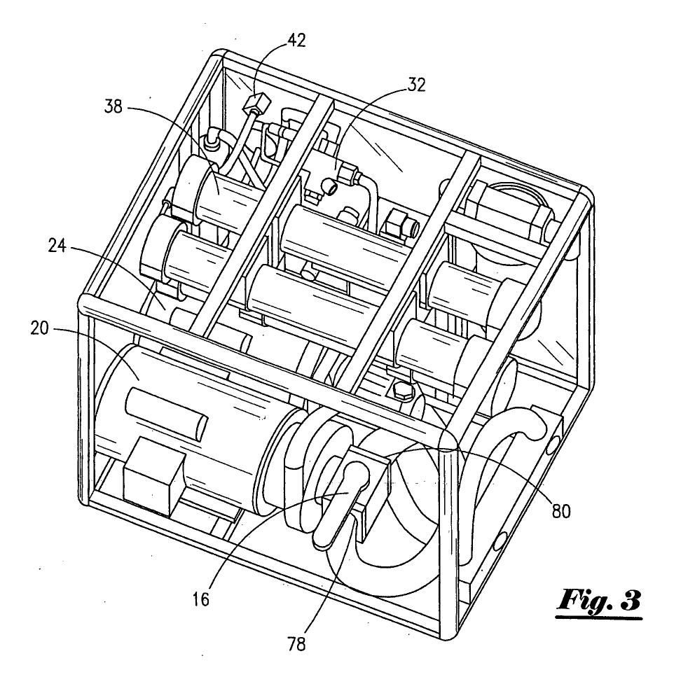

FIG. 3 reveals the backside of unit 10 encased within housing 60. Positioned with housing 60 are the components of unit 10 including positive displacement pump 24, RO membrane 38, fixed orifice 42 and unloading valve 32.

FIG. 3 also depicts valve 16 (shown as a manually actuated valve) and boost pump 20. Seawater inlet 78 and freshwater inlet 80 are also shown. The assembly of valve 16 and boost pump 20 may be included with housing 60 of unit 10.

Unit 10 can function as a pressure washer that uses either freshwater or seawater (or saltwater). To pressure wash with freshwater, valve 16 is actuated to permit the pumping (via boost pump 20 and positive displacement pump 24) of freshwater from freshwater inlet conduit 14 to pressure washer conduit outlet 34 via conduit 30. Freshwater is diverted to conduit 30 via second diverter valve 28.

To pressure wash with seawater, valve 16 is actuated to permit the pumping (via boost pump 20 and positive displacement pump 24) of seawater from seawater inlet conduit 12 to pressure washer outlet 34 via conduit 30.

To produce potable water from seawater, seawater from seawater inlet conduit 12 is pumped (via boost pump 20 and positive displacement pump 24) to second diverter valve 28 which is actuated to permit the flow of seawater through conduit 36 to RO membrane 38. To flush the system, freshwater from freshwater inlet conduit 14 may be pumped (via boost pump 20 and positive displacement pump 24) to second diverter valve 28 which is actuated to permit the flow of freshwater through conduit 36 to RO membrane 38.

Unit 10 is advantageous because it combines two processes, desalination and pressure washing, into one piece of equipment that is simple to use and easy to transport.

While preferred embodiments of the present invention have been described, it is to be understood that the embodiments described are illustrative only and that the scope of the invention is to be defined solely by the appended claims when accorded a full range of equivalence in view of the many variations and modifications naturally occurring to those skilled in the art from perusal hereof.

What is claimed is:

1. An apparatus for desalination of saltwater and for pressure washing using either said saltwater or a freshwater comprising:
a saltwater inlet conduit;
a freshwater inlet conduit;
a first valve in fluid communication with the saltwater and the freshwater inlet conduits;
a low-pressure pump in fluid communication with the first valve;
a high-pressure pump in fluid communication with the low-pressure pump;
a second valve in fluid communication with the high-pressure pump;
a pressure-washer conduit in fluid communication with the second valve;
a desalination assembly in fluid communication with the second valve, the desalination assembly desalinates the saltwater;
a freshwater outlet conduit in fluid communication with the desalination assembly;
a saltwater outlet conduit in fluid communication with the desalination assembly;
wherein the first valve selectively permits a flow of either the saltwater from the saltwater inlet conduit or the freshwater from the freshwater inlet conduit to the second valve;
wherein the second valve selectively permits the saltwater or the freshwater to flow either to the pressure-washer outlet conduit for use in pressure washing or to the desalination assembly.

2. The apparatus according to claim 1, wherein the first valve is a manually operated valve.

3. The apparatus according to claim 1, wherein the first valve is an automatically operated valve.

4. The apparatus according to claim 1, wherein the first valve is a ball valve.

5. The apparatus according to claim 1, wherein the low-pressure pump generates a fluid pressure of at least 30 PSI.

6. The apparatus according to claim 5, wherein the low-pressure pump is a centrifugal pump.

7. The apparatus according to claim 1, wherein the high-pressure pump generates a fluid pressure of at least 1,000 PSI.

8. The apparatus according to claim 7, wherein the high-pressure pump is a positive displacement plump selected from the group consisting of a plunger operated pump and a piston operated pump.

9. The apparatus according to claim 1, wherein the desalination assembly includes a reverse-osmosis membrane.

10. The apparatus according to claim 9, wherein the reverse-osmosis membrane is a spiral wound thin-film composite membrane.

11. The apparatus according to claim 1, further comprising an unloading valve operatively connected to the pressure-washer outlet conduit and in fluid communication with the high-pressure pump; wherein the unloading valve diverts an excess of the saltwater or the freshwater flowing through the pressure-washer outlet conduit to the high-pressure pump.

12. An apparatus for desalination of saltwater and for pressure washing using either the saltwater or a freshwater comprising:
a saltwater inlet conduit;
a freshwater inlet conduit;
a first valve in fluid communication with the saltwater and the freshwater inlet conduits;
a low-pressure pump in fluid communication with the first valve;
a high-pressure pump in fluid communication with the low-pressure pump, the high-pressure pump including a motor that generates a pumping force;
a second valve in fluid communication with the high-pressure pump;
a pressure-washer conduit in fluid communication with the second valve;
a desalination assembly in fluid communication with the second valve, the desalination assembly desalinates the saltwater;
a freshwater outlet conduit in fluid communication with the desalination assembly;
a saltwater outlet conduit in fluid communication with the desalination assembly;
a variable frequency drive assembly operatively connected to the high-pressure pump;
a flow-rate sensor operatively connected to the freshwater outlet conduit and to the variable frequency drive assembly, the flow-rate sensor measuring a flow rate of the freshwater in the freshwater outlet conduit and transmitting the measured flow-rate to the variable frequency drive assembly;
a flow-restriction means operatively associated with the saltwater outlet conduit;
wherein the first valve selectively permits the flow of either saltwater from the saltwater inlet conduit or freshwater from the freshwater inlet conduit to the second valve;
wherein the second valve selectively permits the saltwater or the freshwater to flow either to the pressure-washer outlet conduit for use in pressure washing or to the desalination assembly;
wherein the variable frequency drive assembly selectively increases or decreases a speed of the motor of the high-pressure pump to control a driving pressure of the saltwater across the desalination assembly;
wherein the flow-restriction means regulates the driving pressure of the saltwater across the desalination assembly.

13. The apparatus according to claim 12, wherein the desalination assembly includes a reverse-osmosis membrane.

14. The apparatus according to claim 13, wherein the reverse-osmosis membrane is a spiral wound thin-film composite membrane.

15. The apparatus according to claim 12, wherein the variable frequency assembly includes a PID loop software that selectively increases or decreases said speed of the motor of the high-pressure pump to control the driving pressure of the saltwater across the reverse-osmosis membrane.

16. The apparatus according to claim 12, wherein the flow-restriction means includes a tube having a bore with an inner diameter that is smaller than an inner diameter of the saltwater outlet conduit.

17. The apparatus according to claim 12, wherein the flow-restriction means includes a stem needle valve.

18. The apparatus according to claim 12, further comprising an unloading valve operatively connected to the pressure-washer outlet conduit and in fluid communication with the high-pressure pump; wherein the unloading valve diverts an excess of the saltwater or the freshwater flowing through the pressure-washer outlet conduit to the high-pressure pump.
